(19) United States
(12) Patent Application Publication
(10) Pub. No.: US 2026/0371462 A1
(43) Pub. Date: Nov. 19, 2026

(54) EMITTER-RESPONSIVE RADIATION CONTROL SYSTEM

(71) Applicant: Nairobi Incorporated, Scottsdale, AZ (US)

(72) Inventors: Justin Eugene Evans, New Taipei City (TW); Shuaib Naseem Badat, Cape Town (ZA)

(21) Appl. No.: 19/210,185

(22) Filed: May 16, 2025

(51) Int. Cl. H05B 47/105; H05B 45/325; H05B 47/19

(52) U.S. Cl. CPC H05B 47/105; H05B 45/325; H05B 47/19

(57) ABSTRACT

A modular system for providing electromagnetic radiation includes a base unit and a removable radiation emitter. The emitter contains an identification circuit comprising a resistor with a predefined resistance value. When the emitter is connected, the base unit measures a resulting voltage and determines the emitter's identity based on the resistance. A controller retrieves operational parameters corresponding to the identified emitter from a memory-stored lookup table and adjusts operational characteristics accordingly. The system includes a user device configured to execute a user interface that receives an emitter code and reconfigures display elements based on emitter type and application context. The base unit disables power and transmits a fault signal if an emitter is absent or improperly connected. The system enables safe, plug-and-play emitter replacement and automatic configuration without requiring manual parameter input. The user interface adapts to various use cases, including medical, agricultural, or industrial lighting applications.

### FIELD

Embodiments of the invention generally relate to systems and methods for providing electromagnetic radiation. More specifically, embodiments of the invention concern systems and methods for automatically configuring operational parameters and user interface behavior based on identification of a removable radiation emitter.

### BACKGROUND

Systems for providing electromagnetic radiation, including lighting systems, ultraviolet emitters, and other radiative devices, are widely used in diverse fields such as medical diagnostics, military operations, agriculture, and film production. These systems generally include a radiation-emitting component and associated control electronics to regulate electrical and optical characteristics during operation.

In many contexts, the type of radiation emitter components used may vary depending on the specific application or operational environment. The characteristics and requirements of these components may differ significantly across industries or emitter types, including factors such as wavelength, channel configuration, and safe operating parameters.

As applications for electromagnetic radiation systems continue to expand and diversify, there remains a need in the field for improved systems and methods for managing the integration and operation of interchangeable radiation emitters across varying application domains.

### SUMMARY OF THE INVENTION

In one aspect the invention is directed to a system for providing electromagnetic radiation. In one embodiment, the system includes a radiation emitter configured to be removably attachable to an emitter base unit, wherein the radiation emitter comprises an identification circuit configured to provide a measurable characteristic when connected to the emitter base unit; a controller configured to control operation of the emitter base unit; a memory storing a lookup table that associates values of the measurable characteristic with corresponding values of operational parameters of the emitter base unit. In some embodiments, the system includes a user device in communication with the controller; a user interface (“UI”) configured for execution on the user device, the UI having one or more UI elements associated with providing inputs to the controller and to display data specific to a field of application of use of the radiation emitter. In certain embodiments, the controller is configured to: (a) detect when the radiation emitter is connected to the emitter base unit; (b) apply a signal to the identification circuit to determine a value of the measurable characteristic; (c) retrieve, from the lookup table, the values of the operational parameters associated with the determined value of the measurable characteristic; (d) adjust at least one operational parameter of the emitter base unit based on the retrieved values; (e) detect whether the radiation emitter is absent or improperly connected based on a threshold condition of the measurable characteristic; and (f) in response to detecting the absence or improper connection of the radiation emitter, disable power to the radiation emitter and transmit a fault indication to the user device. The user device can be configured to: (i) receive a code corresponding to the identified radiation emitter from the controller; and (ii) reconfigure the one or more UI elements based on the code to display a control interface specific to the type of radiation emitter. In some embodiments, the radiation emitter is a chip-on-board (COB) light emitting diode (LED) assembly.

In one embodiment of the system for providing electromagnetic radiation, the measurable characteristic is a voltage, a current, a resistance, or a combination thereof. In some embodiments, the controller applies a voltage to the identification circuit and measures a resulting current to determine the value of the measurable characteristic. In certain embodiments, the operational parameters include at least one of a drive voltage, a drive current, a duty cycle, or a pulse width modulation (PWM) setting. In one embodiment, the controller is further configured to apply a predefined default set of operational parameter values if the measurable characteristic does not match any entry in the lookup table. In one embodiment, the controller is further configured to sample the measurable characteristic at a predefined polling interval and validate stability of the value before determining the emitter identity.

In some embodiments of the system for providing electromagnetic radiation, the identification circuit comprises at least one passive electrical component selected from a resistor, capacitor, or inductor. In certain embodiments, the user interface includes a mobile application that displays control options specific to an identified radiation emitter subtype. In one embodiment, the user interface displays an alert requiring system reset upon detection of a radiation emitter removal without a proper shutdown sequence.

In one embodiment of the system for providing electromagnetic radiation, reconfiguring the UI elements includes displaying one or more of: (a) terminology specific to an industry sector; (b) output parameters including brightness, dosage, or wavelength; (c) submenus tailored to a use context; or (d) timers, safety warnings, or compliance indicators. In some embodiments, the controller is configured to periodically sample the measurable characteristic to detect emitter removal or instability. This polling mechanism can facilitate early detection of disconnection, electrical drift, or unsafe conditions, enabling rapid fault response.

In one embodiment of the system for providing electromagnetic radiation, the user interface is configured to present a fault message and disable further input upon detection of emitter removal or disconnection. The user interface may require a system restart before resuming operation. The restart requirement can be triggered upon detection of a resistance value below a threshold indicating emitter removal. In some embodiments, an override interface can be configured to allow a user to disable automatic configuration and manually input operational parameters and/or select a UI profile. The override interface can be accessible through a secured technician menu or external programmer.

Another aspect of the invention concerns a method of operating a system for providing electromagnetic radiation. In one embodiment, the method involves detecting that a radiation emitter has been connected to a device, the radiation emitter comprising an identification circuit; applying a signal to the identification circuit and measuring a resulting response to determine a measurable characteristic associated with the radiation emitter; retrieving, from a lookup table stored in a memory, one or more operational parameter values associated with the determined measurable characteristic; adjusting at least one operational parameter of the device based on the retrieved values; transmitting an identifier corresponding to the radiation emitter to a user interface; reconfiguring, by the user interface, one or more display elements based on the identifier to present interface options specific to the type of radiation emitter; periodically sampling the measurable characteristic to detect whether the radiation emitter has been removed or improperly connected; and in response to detecting an absence or improper connection of the radiation emitter, disabling power to the radiation emitter and generating a user-facing alert requiring corrective action.

In some embodiments of the method of operating the measurable characteristic is a resistance, and the step of determining the measurable characteristic comprises applying a voltage to the identification circuit and measuring a resulting current. In certain embodiments, the lookup table comprises operational parameters selected from: drive voltage, drive current, duty cycle, pulse width modulation setting, channel count, or wavelength range. In one embodiment, the identifier transmitted to the user interface is a numerical code corresponding to the radiation emitter subtype.

In certain embodiments of the method of operating a system for providing electromagnetic radiation, the reconfigured display elements include one or more of: channel sliders, wavelength-specific controls, industry-specific terminology, or restricted function sets. In one embodiment, the method can further include filtering the measured value of the measurable characteristic over a time interval to suppress transient variations before determining the identifier. In some embodiments, sampling occurs at intervals of approximately one second or less.

In one embodiment of the method of operating a system for providing electromagnetic radiation, the user-facing alert includes a prompt to restart the system prior to further operation. In some embodiments, the method can further include disabling all user input to the user interface until the corrective action has been taken. In certain embodiments, the operational parameters retrieved and applied differ for at least four distinct emitter types, each with a corresponding user interface configuration.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a schematic block diagram of a system for automatically configuring operational parameters and user interface behavior based on identification of a removable radiation emitter, according to one embodiment of the invention.

FIG. 2 is a flowchart of a method of operating the system of FIG. 1, according to one embodiment of the invention.

FIG. 3 is a diagram of a first exemplary user interface that can be used with the system of FIG. 1, according to one embodiment of the invention.

FIG. 4 is a diagram of a second exemplary user interface that can be used with the system of FIG. 1, according to one embodiment of the invention.

FIG. 5 is a diagram of a third exemplary user interface that can be used with the system of FIG. 1, according to one embodiment of the invention.

FIG. 6 is a diagram of a fourth exemplary user interface that can be used with the system of FIG. 1, according to one embodiment of the invention.

FIG. 7 is a diagram of a fifth exemplary user interface that can be used with the system of FIG. 1, according to one embodiment of the invention.

FIG. 8 is a diagram of a sixth exemplary user interface that can be used with the system of FIG. 1, according to one embodiment of the invention.

FIG. 9 is a diagram of a seventh exemplary user interface that can be used with the system of FIG. 1, according to one embodiment of the invention.

FIG. 10 is a diagram of an eighth exemplary user interface that can be used with the system of FIG. 1, according to one embodiment of the invention.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing exemplary embodiments in detail, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

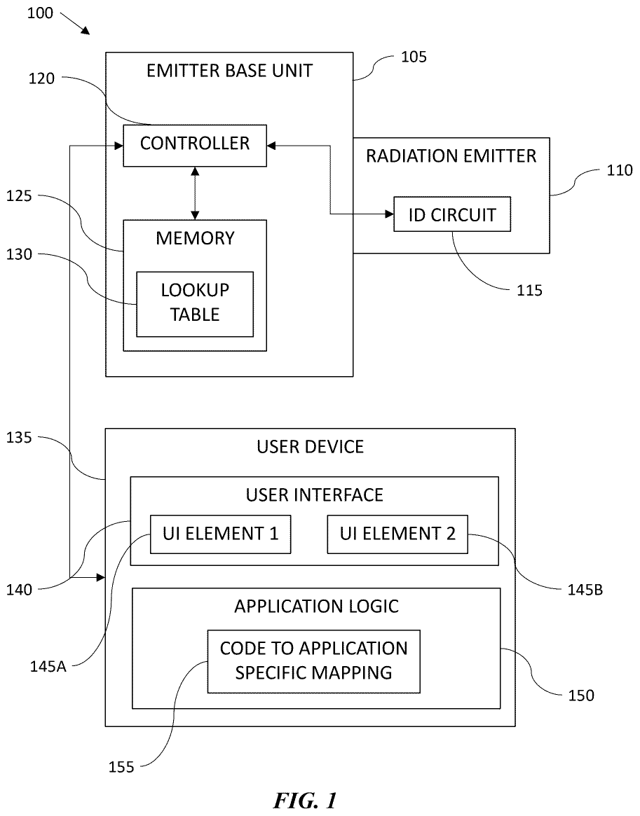

FIG. 1 illustrates system 100 for providing electromagnetic radiation using emitter base unit 105, radiation emitter 110, and user device 135. In one embodiment, radiation emitter 110 can be configured to be removably attachable to emitter base unit 105. Radiation emitter 110 can include identification circuit 115. Identification circuit 115 is configured to provide a measurable characteristic when radiation emitter 110 is connected to emitter base unit 105. In some embodiments, identification circuit 115 includes a passive electrical component, such as a resistor or other element that produces a measurable voltage, current, resistance, or other electrical value when a signal is applied. Radiation emitter 110 may include one or more light emitting elements such as LEDs, UV emitters, or other electromagnetic radiation sources.

Emitter base unit 105 includes controller 120 and memory 125. Memory 125 stores lookup table 130. Lookup table 130 associates values of the measurable characteristic with corresponding values of operational parameters used by emitter base unit 105 to operate emitter 110. In some embodiments, the operational parameters can include drive voltage, current, duty cycle, or pulse width modulation settings used to operate radiation emitter 110.

In one embodiment, controller 120 is configured to detect when radiation emitter 110 is connected to emitter base unit 105. Controller 120 can be further configured to apply a signal to identification circuit 115 and to determine a value of the measurable characteristic based on a response from identification circuit 115. In some embodiments, the measurable characteristic is determined by applying a voltage or current and measuring a resulting electrical value, such as resistance or voltage drop.

In some embodiments, radiation emitter 110 includes a plurality of independently controllable channels. Each channel can correspond to a different spectral output or drive configuration. The number and type of channels are properties of radiation emitter 110 and are identified based on the measurable characteristic provided by identification circuit 115. Emitter base unit 105 need not impose a fixed number of channels; instead, controller 120 can be configured to adapt its operation to the channel configuration of connected radiation emitter 110 by retrieving corresponding operational parameters from lookup table 130.

Based on the determined value of the measurable characteristic, controller 120 retrieves, from lookup table 130, the values of the operational parameters associated with the determined value. Controller 120 can be configured to adjust at least one output parameter of emitter base unit 105 based on the retrieved values, wherein the adjusted parameter can be used to control operation of radiation emitter 110 in accordance with its characteristics.

Controller 120 can also be configured to detect whether radiation emitter 110 is absent or improperly connected to emitter base unit 105. In some embodiments, this determination is based on whether the measurable characteristic falls outside a predefined threshold or acceptable range, such as in the case of an open circuit or floating connection. Upon detecting such a condition, controller 120 disables power to radiation emitter 110 and transmits a fault indication to user device 135.

User device 135 is in communication with controller 120. In some embodiments, user device 135 communicates with controller 120 using a wired or wireless communication protocol. User device 135 is configured to receive a code from controller 120. The code corresponds to the identity of radiation emitter 110, and may uniquely identify a type, category, or configuration of radiation emitter 110.

User device 135 includes user interface 140 and application logic 150. User interface 140 can include UI elements 145A and 145B, which are associated with displaying data and receiving user input related to the operation of emitter base unit 105. In some embodiments, UI elements 145A and 145B include graphical controls, display regions, input selectors, or interactive widgets. In some embodiments, user device 135 includes an override interface (not shown) integrated with user interface 140 and application logic 150. The override interface can be configured to facilitate a user or technician to disable automatic configuration behavior normally triggered by controller 120 in response to the measurable characteristic provided by identification circuit 115. When activated, the override interface enables manual input of operational parameters—such as drive current, voltage, or PWM settings—through UI elements 145A and 145B. It may also allow the user to select a desired UI configuration from mapping 155, independent of the emitter identity code transmitted by controller 120. This functionality is particularly useful for testing, calibration, or use with emitters that lack a functional identification circuit.

Application logic 150 includes mapping 155, which stores a mapping between received codes and UI configurations corresponding to different types of radiation emitters 110. Application logic 150 is configured to cause user interface 140 to reconfigure based on the received code. In some embodiments, application logic 150 selects one of a plurality of predefined interface configurations based on the mapping and renders user interface 140 with a layout, set of controls, or set of information specific to the field of application of the connected radiation emitter 110.

In some embodiments, application logic 150 is further configured to modify, disable, or interrupt user interface 140 in response to receiving a fault indication from controller 120. In such embodiments, application logic 150 may display an alert or error screen indicating that radiation emitter 110 is absent or improperly connected, and may restrict access to the control functions of user interface 140 until the fault condition is resolved.

System 100 can be implemented using discrete hardware components or integrated systems. In some embodiments, controller 120 is implemented as a microcontroller or digital signal processor, and memory 125 comprises non-volatile memory such as EEPROM or flash memory. User device 135 can be implemented as a mobile device, tablet, computer, or dedicated control unit, and user interface 140 can be rendered by application logic 150 using a native application or web-based interface.

As used herein, “reconfigured UI” refers to a user interface that dynamically changes its layout, control logic, terminology, graphical elements, or displayed metrics based on emitter identity and/or application context, such that users in distinct domains (e.g., medical vs. media) are presented with operationally relevant information and controls.

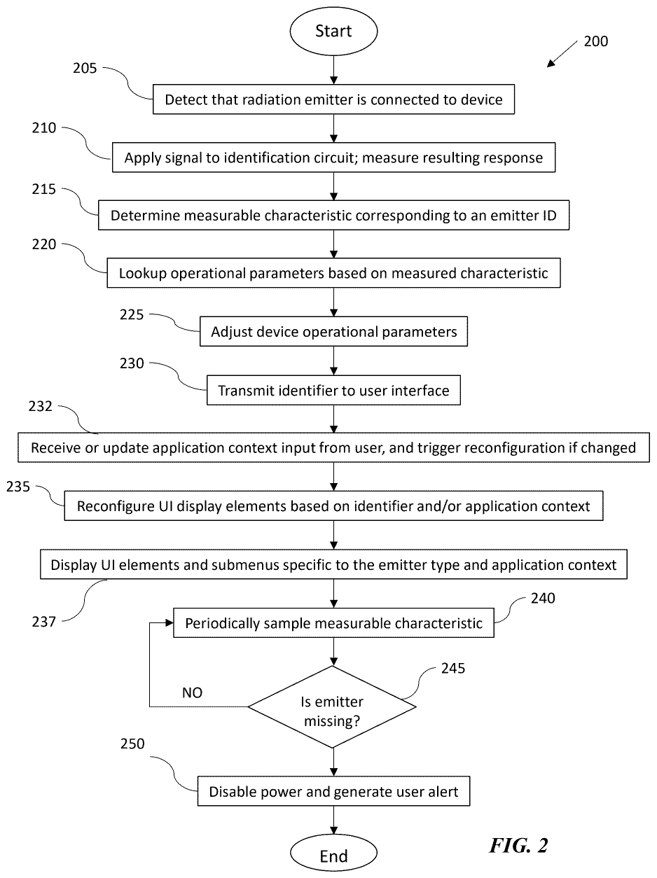

FIG. 2 illustrates a method 200 of operating a system for providing electromagnetic radiation. In one embodiment, method 200 is performed by system 100 of FIG. 1. The method begins at step 205, where controller 120 detects that radiation emitter 110 has been connected to emitter base unit 105. Detection may include identifying a completed circuit path, a physical or electrical connection event, or a change in impedance across the emitter terminals.

At step 210, controller 120 applies a signal, such as a known voltage or current, to identification circuit 115. A resulting electrical response is measured, which may include a voltage drop, current level, or another electrical parameter derived from the applied signal.

At step 215, controller 120 determines a measurable characteristic based on the measured response. In some embodiments, the measurable characteristic is a resistance, voltage, or current value derived from the response. Controller 120 uses the measurable characteristic to identify the type of radiation emitter 110 connected to emitter base unit 105. For example, a resistance value of 1.3 ohms may correspond to a known emitter ID. The emitter ID may be used as an index or key to access a predefined set of configuration parameters stored in a lookup table.

At step 220, controller 120 uses the measured characteristic or the corresponding emitter ID to retrieve, from lookup table 130 stored in memory 125, one or more operational parameters associated with the identified emitter. The operational parameters may include drive voltage, drive current, duty cycle, pulse width modulation (PWM) settings, channel-specific current limits, timing parameters, or thermal protection thresholds.

At step 225, controller 120 adjusts at least one operational parameter of emitter base unit 105 based on the retrieved values. Adjustment may include configuring the driver electronics to match the electrical requirements of the identified emitter or loading a firmware module that provides device-specific functionality or protection.

At step 230, controller 120 transmits an identifier corresponding to the identified radiation emitter to user device 135. In some embodiments, the identifier is a code or digital token associated with the emitter ID used to determine the operational parameters.

At step 232, user device 135 receives or updates application context input from a user through user interface 140. The application context may specify an operational domain for the radiation emitter, such as medical, media production, agricultural, or industrial lighting. In some embodiments, the context is selected by the user from a menu, detected from a profile setting, or inferred from a connected accessory or prior session. In response to receiving new or updated application context, user device 135 may trigger a reconfiguration of one or more UI display elements to match the newly indicated operational environment. In some embodiments, user interface 140 is reconfigured based not only on the identity of the radiation emitter but also on an application context selected or inferred independently. For instance, a given emitter may be used in both a medical and a cinematographic setting. Application logic 150 can receive the emitter code and the context input separately and map the combination to a context-specific interface layout and feature set. This dual-parameter approach improves usability by suppressing irrelevant controls and terminology.

At step 235, user device 135 reconfigures display elements of user interface 140 based on the received identifier or the application context. Application logic 150 uses mapping 155 to associate emitter identifiers and application contexts with corresponding UI layouts, settings, control options, or access restrictions.

At step 237, user interface 140 can display UI elements and submenu options specific to the type of emitter and application context. In one example, a medical emitter with three output channels may cause user interface 140 to display safety timers, UV dosage indicators, or compliance warnings, while a media emitter may trigger display of color temperature presets and creative light shaping tools.

At step 240, controller 120 periodically samples the measurable characteristic associated with identification circuit 115 to monitor the electrical continuity and presence of radiation emitter 110. The periodic sampling may occur on a predefined interval, such as once per second.

At decision step 245, controller 120 determines whether the measured characteristic has changed in a manner indicating that radiation emitter 110 is missing, disconnected, or improperly connected. In one embodiment, a measured resistance of zero ohms indicates an open circuit, which corresponds to an unsafe or invalid condition.

If an emitter is missing or improperly connected, the method proceeds to step 250, where controller 120 disables power to radiation emitter 110 and generates a user-facing alert. The alert is presented through user interface 140 and may include a pop-up notification, sound, vibration, or system lockout until corrective action is taken.

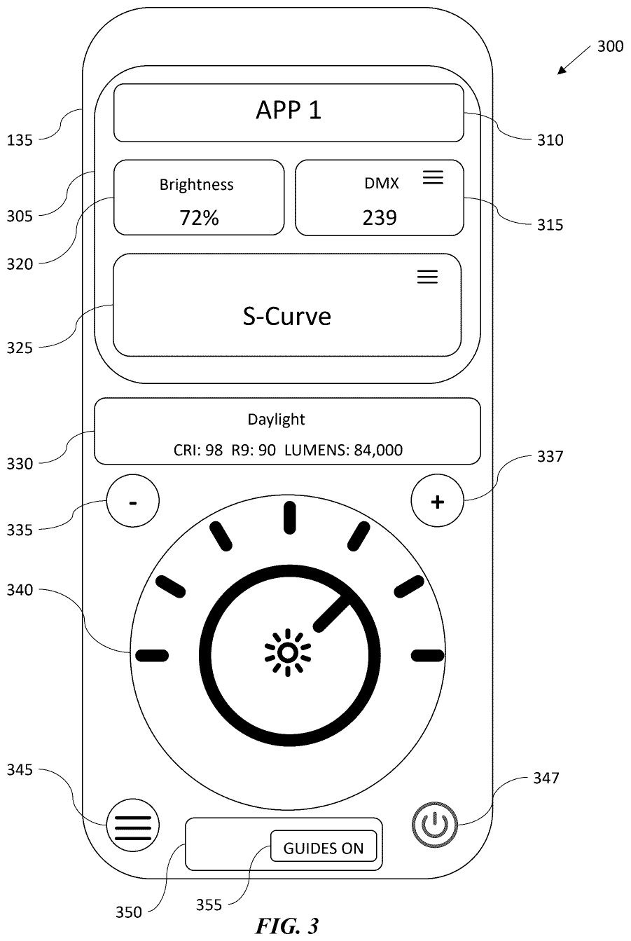

Each of FIGS. 3-10 illustrates an embodiment of a user interface configured for execution on user device 135 in response to identification of radiation emitter 110 and, optionally, a specified application context. Each user interface includes control summary elements, spectral attribute panels, rotary brightness controls, and additional interface controls. Common interface controls include menu button 345, power button 347, and guides toggle 355. Menu button 345 provides access to settings and system-wide options. Power button 347 controls on/off or standby states of emitter base unit 105 via user device 135. Guides toggle 355 enables or disables contextual help overlays within the UI. The layout and selection of elements for each user interface screen are determined by application logic 150 based on the emitter identifier and application context retrieved using mapping 155.

In some embodiments, each emitter/application combination can result in a distinct UI layout including but not limited to: different primary metrics (e.g., CRI vs. PAR vs. dosage), application-specific labels (e.g., “Blue Mountain Coffee” or “UVC”), visual icons (e.g., leaf for agriculture, shield for military), and control structures (e.g., RGB sliders vs. safety timers). These differences are functional and facilitate proper use of system 100 in different operational domains.

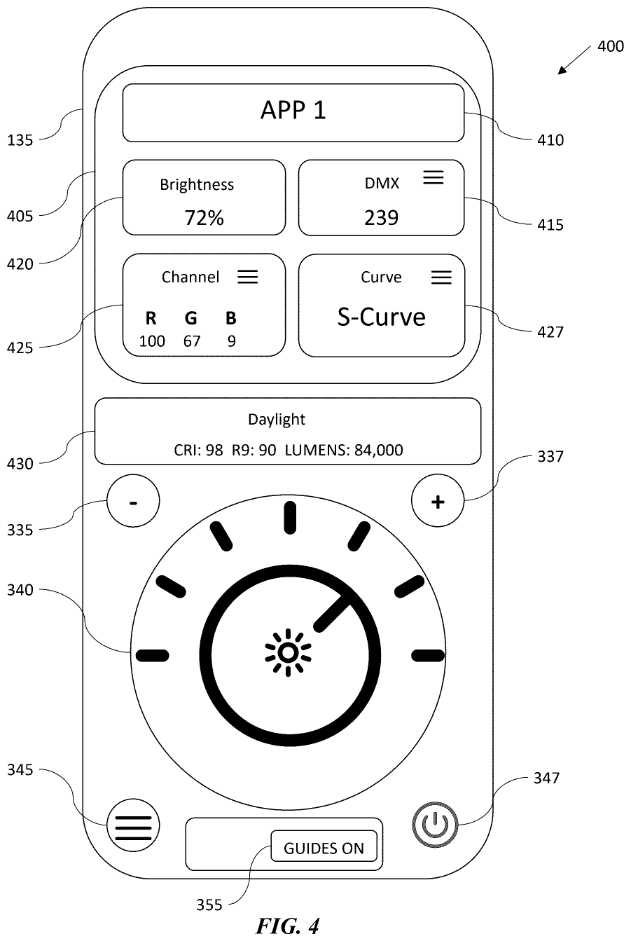

FIG. 3 and FIG. 4 illustrate user interfaces 300 and 400 for media lighting applications using radiation emitters 110 with one and three output channels, respectively. Each interface includes a control summary region (305 or 405) with application label (310 or 410), DMX address indicator (315 or 415), brightness level indicator (320 or 420), and curve profile label (325 or 427), where brightness is shown as a percentage and the selected modulation curve (e.g., “S-Curve”) indicates the output response. In the three-channel embodiment of FIG. 4, a channel display 425 shows red, green, and blue output levels (e.g., 100, 67, and 9), which can be configured to be adjustable by the user. Spectral attribute panels 330 and 430 identify the emitter classification (e.g., “Daylight”) and present emitter-specific values including CRI, R9, and lumens. Rotary control 340, common to both interfaces, provides output adjustment and includes a light output icon. All elements are selected and arranged by application logic 150 in response to the detected emitter type and use context.

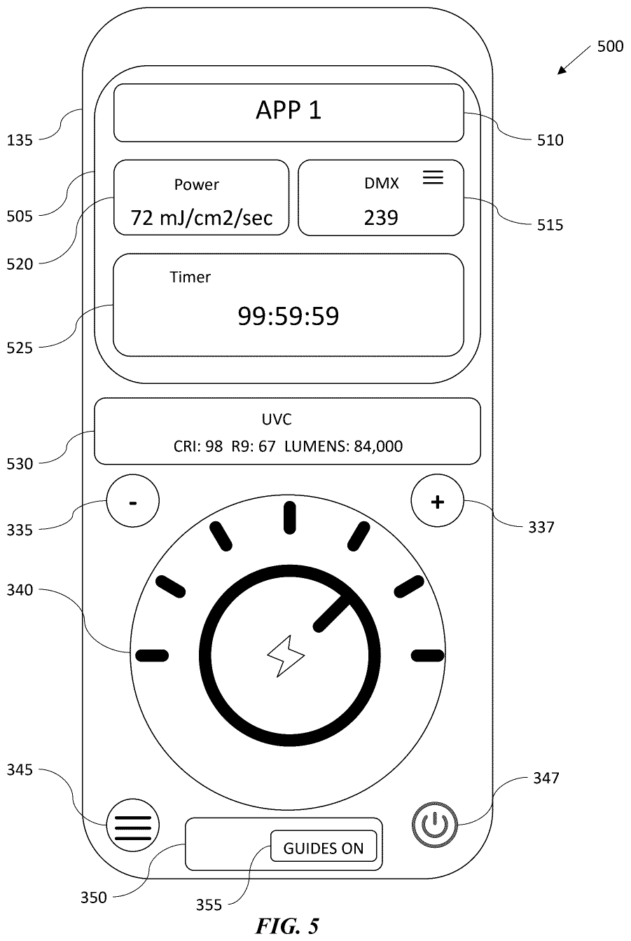

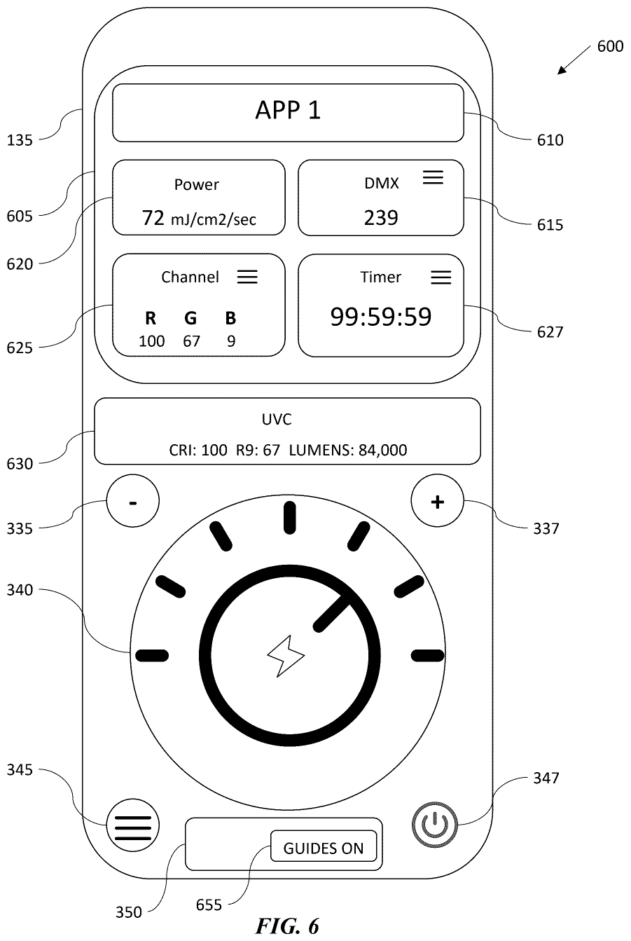

FIG. 5 and FIG. 6 illustrate embodiments of user interfaces 500 and 600 configured for medical lighting applications using single-channel and three-channel radiation emitters, respectively. Both interfaces display a power level indicator (520 or 620) showing a dosage value of “72 mJ/cm²/sec,” a DMX address indicator (515 or 615) showing “239,” and a timer display (525 or 627) indicating “99:59:59.” Spectral attributes panels 530 and 630 identify the emitter type as “UVC” and display corresponding CRI, R9, and lumen values (e.g., 98 or 100, 67, and 84,000). The three-channel configuration of FIG. 6 includes a channel panel 625 showing red, green, and blue output levels (e.g., 100, 67, and 9).

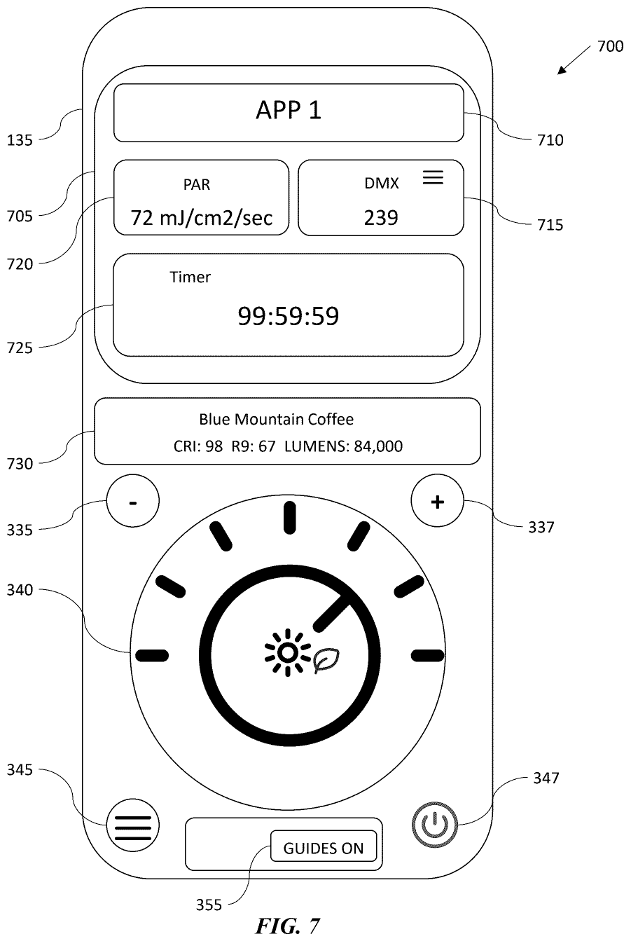

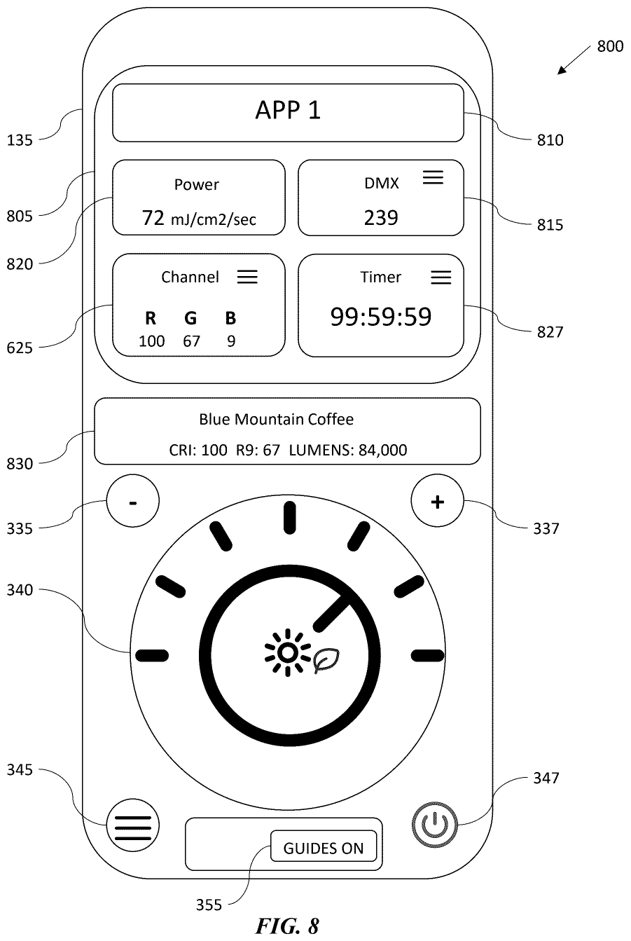

FIG. 7 and FIG. 8 illustrate user interfaces 700 and 800, respectively, configured for agricultural lighting applications. In both configurations, control summary region 705 includes application label 710 (“APP 1”), PAR output indicator 720 (e.g., “72 mJ/cm²/see”), DMX address indicator 715 (e.g., “239”), and timer display 725 (e.g., “99:59:59”). Spectral attributes panel 730 displays the emitter profile (e.g., “Blue Mountain Coffee”) and corresponding values for CRI, R9, and lumens (e.g., 98, 67, 84,000). In FIG. 8, where the emitter includes three output channels, channel panel 625 is presented to show individual red, green, and blue channel levels (e.g., 100, 67, 9). Rotary control 340 in both embodiments includes a stylized sun-and-leaf icon, consistent with a horticultural emission profile.

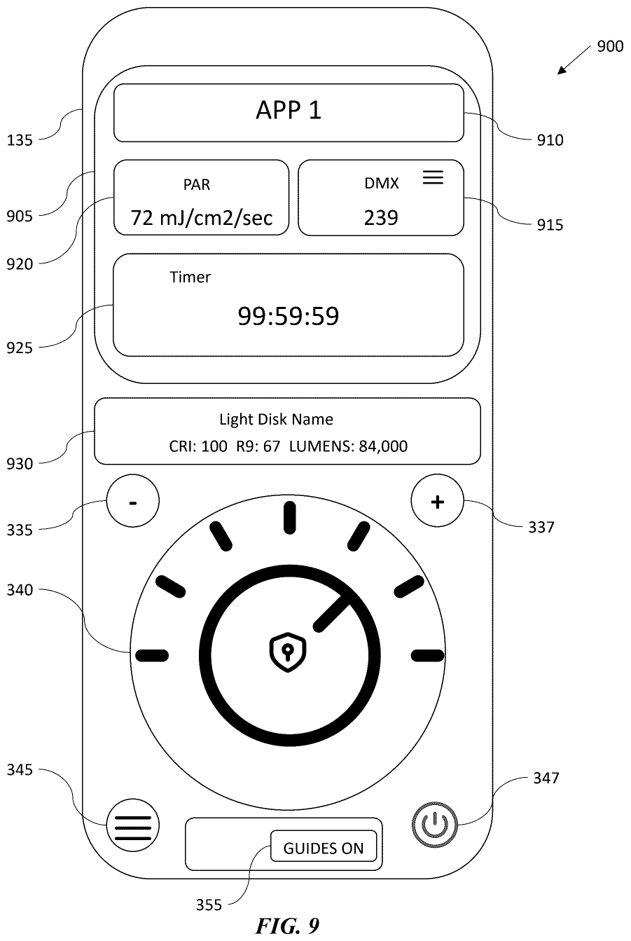

FIG. 9 illustrates user interface 900 associated with a military or security lighting application using a single-channel radiation emitter. Control summary region 905 includes application label 910 (“APP 1”), PAR output indicator 920 showing “72 mJ/cm²/sec,” DMX address indicator 915 showing “239,” and timer display 925 with a value of “99:59:59.” Spectral attributes panel 930 includes a generic identifier (e.g., “Light Disk Name”) and corresponding performance values (CRI: 100, R9: 67, Lumens: 84,000). Rotary control 340 displays a shield icon, indicating a secure or tactical radiation profile.

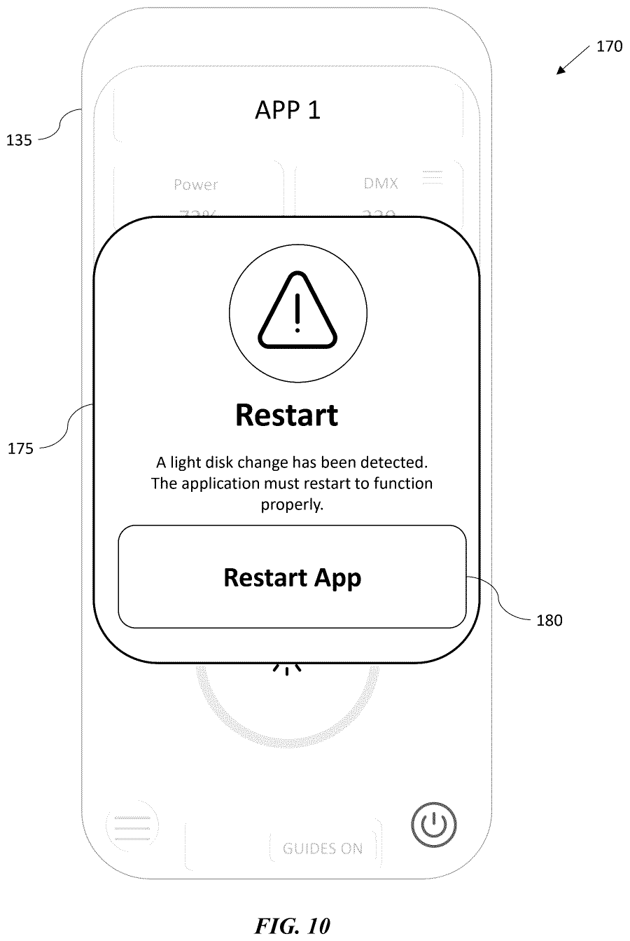

FIG. 10 illustrates a user interface screen 170 showing a fault notification triggered by a radiation emitter change. Screen 170 is displayed on user device 135 and includes an alert overlay panel 175 rendered on top of the standard interface layout. Alert overlay panel 175 includes a graphical warning icon, a textual message notifying the user that a light disk change has been detected, and a prompt to restart the control application. A restart button 180 is displayed within overlay panel 175 and is selectable by the user to initiate an application restart. In one embodiment, overlay panel 175 is generated in response to receiving a new emitter identifier or detecting a measurable characteristic that does not correspond to the currently active emitter. In some embodiments, overlay panel 175 may be displayed automatically when a resistance value of zero is detected or when the application logic determines that a change of emitter has occurred without a proper reset, thereby requiring the system to reload the appropriate user interface configuration. Upon detecting emitter removal or improper reconnection, user interface 140 can enter a fault state in which operational controls are locked. A visual overlay can be presented prompting the user to restart the application. No user input is accepted until this restart is completed, ensuring system integrity and preventing unsafe behavior.

As previously described with reference to FIG. 1, in one embodiment, radiation emitter can include an identification circuit, such as a resistor. Emitter base unit 105 can measure the resistance and map the value to a corresponding emitter code. This code can be used to retrieve operational parameters.

The table below illustrates a representative subset of this mapping. For each emitter type, a resistance is determined by emitter base unit 105 based on a measurement of the identification circuit 115. This resistance is then used to query lookup table 130, which returns a corresponding emitter code. The emitter code can be used to select operational parameters relevant to the identified emitter, including the number of output channels, spectral classification (e.g., UV-C, RGB, IR), application-specific user interface behavior, and safety rules. In some embodiments, additional operational parameters can include drive current, PWM duty cycle, timing sequences, brightness scaling, or thermal protection settings. These parameters govern how emitter base unit 105 controls radiation emitter 110 during operation and how user interface 140 reconfigures its display and controls to suit emitter 110 and its intended application.

| | | Measured | Detected | | | | |
|---|---|---|---|---|---|---|---|
| Emitter | Wavelength | Resistance | Pin | Emitter | | Resistor | |
| Type | (nm) | (kΩ) | Voltage | Code | Channels | Type* | |
| UV-C | 265 | 787 | 0.5 | 010 | 1 | 787 | kΩ |
| Medical | | | | | | | |
| UV-A | 365 | 200 | 0.57 | 040 | 1 | 200 | kΩ |
| Medical | | | | | | | |
| Blue | 450 | 150 | 0.75 | 060 | 1 | 150 | kΩ |
| RGB | NA | 62 | 1.67 | 120 | 3 | 62 | kΩ |
| Chlorophyll | NA | 47 | 2.10 | 150 | 3 | 47 | kΩ |
| A Targeted | | | | | | | |
| Military IR | 940 | 28 | 3.16 | 220 | 1 | 28 | kΩ |

*The resistor type refers to a commercially available discrete resistor installed in the emitter's identification circuit. It is selected to produce the indicated measured resistance under standard circuit conditions.

In the exemplary system 100, each radiation emitter 110 includes an identification circuit 115 comprising, for example, a fixed resistor. When emitter 110 is connected to emitter base unit 105, emitter base unit 105 applies a voltage and measures the resulting voltage at a detection pin. From this, controller 120 determines a corresponding resistance value, which is used to retrieve an emitter code from lookup table 130. That emitter code can then be used to configure operational parameters and user interface behavior.

In some embodiments, emitter base unit 105 provides electrical power to radiation emitter 110 upon connection. However, radiation emitter 110 cannot be meaningfully controlled unless user device 135 receives and interprets the emitter code. The emitter code can be a three-digit identifier obtained via lookup table 130, which maps a measured resistance value to a known emitter configuration. An application on user device 135 can be configured to function as the primary control interface and uses the received emitter code to activate a corresponding submenu module corresponding to the identified emitter. Application logic 150 can be configured such that without receiving this code, the application does not display the appropriate controls, and system 100 remains functionally inactive, even if power is present at the radiation emitter 110. This structure ensures both configurational integrity and operational safety by requiring synchronized emitter identification and user interface initialization before control is enabled.

In some embodiments, ID circuit 115 is configured with a resistor sufficiently different from the resistors of other emitter types to ensure that if system 100 is operating at a different ambient temperature, which will change the resistance in ID circuit 115, the resistance is not misread as belong to another emitter type.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible considering the above teachings without departing from the following claims.

1. A modular system for providing electromagnetic radiation, the system comprising:
an emitter base unit;
a radiation emitter configured to be removably attachable to the emitter base unit, the radiation emitter having an identification circuit configured to provide a measurable characteristic when connected to the emitter base unit;
wherein the emitter base unit comprises:
a controller configured to control operation of the radiation emitter; and
a memory storing a lookup table that associates values of the measurable characteristic with corresponding values of operational parameters of the emitter base unit;
a user device in communication with the controller;
a user interface (“UI”) configured for execution on the user device, the UI having one or more UI elements associated with providing inputs to the controller and to display data specific an application context associated with the radiation emitter;
wherein the controller is configured to:
detect when the radiation emitter is connected to the emitter base unit;
apply a signal to the identification circuit to determine a value of the measurable characteristic;
retrieve, from the lookup table, the values of the operational parameters associated with the determined value of the measurable characteristic;
adjust at least one operational parameter of the emitter base unit based on the retrieved values;
detect whether the radiation emitter is absent or improperly connected based on a threshold condition of the measurable characteristic; and
in response to detecting the absence or improper connection of the radiation emitter, disable power to the radiation emitter and transmit a fault indication to the user device;
wherein the user device is configured to:
receive a code corresponding to the identified radiation emitter from the controller; and
reconfigure the one or more UI elements based on the code to display a control interface specific to the type of radiation emitter.

2. The system of claim 1, wherein the measurable characteristic is a voltage, a current, a resistance, or a combination thereof.

3. The system of claim 1, wherein the operational parameters include at least one of a drive voltage, a drive current, a duty cycle, or a pulse width modulation (PWM) setting.

4. The system of claim 1, wherein the user device comprises an override interface integrated with the user interface, the override interface configured to disable automatic configuration based on the measurable characteristic and to enable manual input of operational parameters and/or selection of a user interface configuration.

5. The system of claim 1, wherein the user interface comprises a mobile application that displays control options specific to an identified radiation emitter subtype.

6. The system of claim 1, wherein the controller is further configured to sample the measurable characteristic at a predefined polling interval and validate stability of the value before determining the emitter identity.

7. The system of claim 1, wherein the user interface is further configured to receive an application context input from a user, and wherein the one or more UI elements are reconfigured based on both the code and the application context.

8. The system of claim 1, wherein the controller is further configured to transmit a fault indication to the user device upon detection of disconnection of the radiation emitter, and wherein the user interface is further configured to disable at least some control inputs and require a user-initiated reset before resuming operation.

9. The system of claim 1, wherein the operational parameters and the user interface configuration are both selected from a mapping based on the measurable characteristic, such that emitter identity simultaneously determines operation of the emitter base unit and the behavior of the user interface in a specific application.

10. A method of operating a system for providing electromagnetic radiation, the method comprising:
detecting that a radiation emitter has been connected to a device, the radiation emitter comprising an identification circuit;
applying a signal to the identification circuit and measuring a resulting response to determine a measurable characteristic associated with the radiation emitter;
retrieving, from a lookup table stored in a memory, one or more operational parameter values associated with the determined measurable characteristic;
adjusting at least one operational parameter of the device based on the retrieved values;
transmitting an identifier corresponding to the radiation emitter to a user interface;
reconfiguring, by the user interface, one or more display elements based on the identifier to present interface options specific to the type of radiation emitter;
periodically sampling the measurable characteristic to detect whether the radiation emitter has been removed or improperly connected; and
in response to detecting an absence or improper connection of the radiation emitter, disabling power to the radiation emitter and generating a user-facing alert requiring corrective action.

11. The method of claim 10, wherein the measurable characteristic is a resistance, and the step of determining the measurable characteristic comprises applying a voltage to the identification circuit and measuring a resulting current.

12. The method of claim 10, wherein the lookup table comprises operational parameters selected from: drive voltage, drive current, duty cycle, pulse width modulation setting, channel count, or wavelength range.

13. The method of claim 10, wherein the identifier transmitted to the user interface is a numerical code corresponding to the radiation emitter subtype.

14. The method of claim 10, wherein the reconfigured display elements include one or more of: channel sliders, wavelength-specific controls, industry-specific terminology, or restricted function sets.

15. The method of claim 10, further comprising filtering the measured value of the measurable characteristic over a time interval to suppress transient variations before determining the identifier.

16. The method of claim 10, wherein the user-facing alert includes a prompt to restart the system prior to further operation.

17. The method of claim 10, wherein the operational parameters retrieved and applied differ for a plurality of distinct emitter types, each with a corresponding user interface configuration.

18. A modular system for providing electromagnetic radiation, the system comprising:
an emitter base unit;
a radiation emitter configured to be removably attachable to the emitter base unit, the radiation emitter having an identification circuit configured to provide a measurable characteristic when connected to the emitter base unit;
wherein the emitter base unit comprises:
a controller configured to control operation of the radiation emitter; and
a memory storing a lookup table that associates values of the measurable characteristic with corresponding values of an emitter code;
a user device in communication with the controller;
a user interface (“UI”) configured for execution on the user device, the UI having one or more UI elements associated with providing inputs to the controller and to display data specific an application context associated with a radiation emitter identified by the emitter code;
wherein the controller is configured to:
detect when the radiation emitter is connected to the emitter base unit;
apply a signal to the identification circuit to determine a value of the measurable characteristic;
retrieve, from the lookup table, an emitter code associated with the value of the measurable characteristic; and
adjust at least one operational parameter of the emitter base unit based on operational values associated with the emitter code; and
wherein the user device is configured to:
receive the emitter code from the controller; and
reconfigure the one or more UI elements based on the emitter code to display a control interface specific to the type of radiation emitter.

19. The system of claim 18, wherein the controller is further configured to detect whether the radiation emitter is absent or improperly connected based on a threshold condition of the measurable characteristic.

20. The system of claim 19, wherein the controller is further configured to, in response to detecting the absence or improper connection of the radiation emitter, disable power to the radiation emitter and transmit a fault indication to the user device.
